(19) United States
(12) Patent Application Publication
(10) Pub. No.: US 2025/0196562 A1
(43) Pub. Date: Jun. 19, 2025

(54) MULTI-CHAMBER AIR SPRING CONTROL

(71) Applicant: JAGUAR LAND ROVER LIMITED, Warwickshire (GB)

(72) Inventor: Adrian BOUARU, Whitley, Coventry, Warwickshire (GB)

(21) Appl. No.: 18/847,380

(22) PCT Filed: Mar. 30, 2023
(86) PCT No.: PCT/EP2023/058313

§ 371 Date: Sep. 16, 2024

(30) Foreign Application Priority Data
Mar. 30, 2022 (GB) 2204529.8

(51) Int. Cl. B60G 17/052

(52) U.S. Cl. CPC B60G 17/0528; B60G 2202/152; B60G 2500/2046

(57) ABSTRACT

Aspects relate to control systems (100), air spring systems (200, 250), vehicle suspension systems, vehicles (600), methods and computer software for a multi-chamber air spring for a vehicle. The multi-chamber air spring comprises at least a first chamber (204, 254) and a second chamber (206, 256) and a valve (210, 260) therebetween. An example control system (100) is configured to: receive a close signal to cause the valve to close; determine a current profile (400, 420, 440) in dependence on the close signal, the current profile indicative of a current to apply to the valve to cause the valve to close, wherein the current profile comprises a curved portion (408, 428, 448) in which the current increases with a decreasing slope of curvature as a function of time; and output a signal to the valve indicative of the current profile, the signal configured to cause the valve to close according to the current profile.

### TECHNICAL FIELD

The present disclosure relates to air springs such as those used in vehicle suspension systems; in particular, so-called multi-chamber air springs, in which the air volume may be varied. Aspects relate to control systems for such air springs, air spring systems, vehicle suspension systems, vehicles, methods and computer software.

### BACKGROUND

Vehicles (e.g. petrol, diesel, electric, hybrid) may comprise active suspension systems for maintaining vehicle stability and ride comfort. Active suspension systems may comprise dynamic air springs as part of the suspension system. A dynamic air spring may also be called an adaptive air spring, multi-chamber air spring, or an additional switchable volume (ASV) air spring. Such air springs comprise a set of physical volumes which are connected via adjustable restrictions. An example multi-chamber air spring may comprise two volumes, connected via one valve, such as an electronically adjustable valve. This allows for separate spring rates to be effected by having the valve closed or open. Another example multi-chamber air spring may comprise three volumes, connected via two valves such as electronically adjustable valves. This allows for more possible separate spring rates by having the valves closed or open in different combinations.

Switching between volumes may be controlled by a controller hosting a control algorithm. The control algorithm may monitor an array of sensor inputs from the vehicle and select the most appropriate state for the suspension system. Different states equate to different spring characteristics (e.g. stiffness) provided by adjusting the air volumes within each air spring which is used to provide a suspension force. Selection between the air volumes may be performed by opening/closing valves within the air spring to control the air volume in use. The spring state selection of the air spring may be linked to the drive mode of the vehicle (e.g. comfort mode, dynamic mode) and/or may be linked to the driving use case (e.g. off-road driving, city driving, track driving).

When electronic multi-chamber air spring valves are electrically energized/de-energized (i.e. closed/opened), they may exhibit a “knock” noise. This may occur when the valve reaches a travel limit, for example when fully open or fully closed. In some examples, the valve may be a solenoid valve, which may be operated using a hit-hold current profile. In a hit-hold operation, the valve solenoid may reach a first current in a “hit” phase to cause the valve to be fully open or be fully closed, then the valve solenoid may reach a second higher current in a “hold” phase to ensure the valve position is held. Such current profiles may provide a fast switching time, but may also generate a high level of knock noise. It may be undesirable for a knock noise to be produced each time a valve is energised, as this may be perceived as a fault by the end user, and may be particularly noticeable in relation to electrical vehicle use which tend to operate more quietly than petrol/diesel vehicles. It may also be desirable to control the valve to reduce wear and tear/fatigue caused by repeated opening and closing while maintain good responsiveness to open/close signals.

It is an aim of the present disclosure to address one or more of the disadvantages associated with the prior art.

### SUMMARY OF THE INVENTION

Aspects and embodiments of the invention provide control systems for air springs, air spring systems, vehicle suspension systems, vehicles, methods and computer software, as claimed in the appended claims

According to an aspect there is provided a control system for a multi-chamber air spring for a vehicle, the multi-chamber air spring comprising at least a first chamber and a second chamber and a valve therebetween, the control system comprising one or more controllers, the control system configured to: receive a close signal to cause the valve to close; determine a current profile in dependence on the close signal, the current profile indicative of a current to apply to the valve to cause the valve to close, wherein the current profile comprises a curved portion in which the current increases with a decreasing slope of curvature as a function of time; and output a signal to the valve indicative of the current profile, the signal configured to cause the valve to close according to the current profile.

Advantageously, the curved portion may provide control over the valve closure which provides both quick closure from the initial steeper part of the curve for good responsiveness, and a slower (softer) closure when the valve is almost closed to reduce knocking sounds from valve end contact on closure and to reduce mechanical impact on the valve for extended mechanical life of the valve. Notably, the rate of change of the current may start to be reduced prior to the valve reaching its closed position.

The valve may be configured to close by moving on a closure travel path from an open position at the start of the closure travel path in which the first and second chambers are connected, to a closed position at the end of the closure travel path in which the first and second chambers are separated by the valve, wherein the curved portion of the current profile is indicative of a current to apply to the valve at the end of the closure travel path to cause the valve to reach the end of the closure travel path. Notably, the rate of change of the current may start to be reduced prior to the valve reaching its closed position. Advantageously, the curved portion may define the valve movement at the end of the travel to a closed position where the curved profile can act to provide slower (softer) closure.

The current profile may comprise a linear portion and the curved portion. Thus the curved portion may form a part of the overall current profile and there may be flexibility in the part of the current profile where the curved portion is, for flexibility in controlling the valve movement.

The current profile may comprise the linear portion followed by the curved portion. In this way most of the valve closure may take place using the linear current increase and the curved current increase takes place in the part of the closure where it may be most beneficial (i.e. close to and causing complete closure of the valve).

The current profile may comprise a first linear portion, followed by the curved portion, followed by a second linear portion. The second linear portion may represent a current applied once the valve is closed to ensure a good, pressed seal against the valve wall, i.e. the “hit” portion of the hit-hold motion.

The curved portion may be indicative of a logarithmic current variation as a function of time. The logarithmic variation may comprise, for example, a log₂, log₁₀, In (logₑ) function, depending on the particular curve desired. The curved portion may be indicative of a circular or oval curve as a function of time in some examples. In other examples other mathematical curve shapes may be represented by the curved portion.

The control system may be configured to determine the current profile by one or more of: retrieving the current profile from a stored profile repository; and determining at least part of the current profile in accordance with one or more detected vehicle parameters.

Thus in some examples the current profile may be a fixed profile, for example retrieved from a look-up table. In some examples the current profile may be dynamic profile determined in dependence on a vehicle parameter such as road surface, speed, or other parameter representing the current driving environment.

The current profile may further comprise a decreasing current portion. The control system may be configured to:

receive an open signal to cause the valve to open; determine a current profile in dependence on the open signal, the current profile indicative of a decreasing current to apply to the valve to cause the valve to open; and output the current profile to the valve to cause the valve to open according to the current profile. Thus the current profile may also determine how the value is opened using the decreasing current portion, as well as closed using the increasing current portion.

The valve may be configured to open by moving on an opening travel path from the closed position at the start of the opening travel path in which the first and second chambers are separated by the valve, to the open position at the end of the opening travel path in which the first and second chambers are connected, and the current profile may be indicative of a decreasing current comprising a linear decreasing current portion to apply to the valve to cause the valve to move from the closed position to the open position. Thus the current profile controlling the valve opening may have a current which ramps down rather than a current which (substantially) instantaneously drops, to soften the valve opening action.

The decreasing current portion of the current profile may comprise the decreasing linear portion and a further decreasing portion. Thus the decreasing current portion may have a profile which is not only linear with a single gradient, but has some other profile shape too, for example a further linear gradient and/or a further curved portion e.g. an exponential curve.

The current profile may comprise: a closure portion indicative of a current configured to cause the valve to close, the closure portion to apply to the valve to cause the valve to close, the closure portion comprising a first linear current increase and the curved portion; a hold portion at a constant non-zero current indicative of a current configured to maintain the valve in a closed position; and an opening portion indicative of a current configured to cause the valve to open, the opening portion comprising a linear current decrease. Such a current profile may provide the benefits of the curved portion of the closing current profile while remaining relatively simple to perform where a particular valve action control is not as important.

The closure portion may further comprise a second linear current increase following the curved portion. Such a second linear current increase may control a “hold” movement of a “hit-hold” closure movement to help ensure a good closure seal.

The valve may be configured to operate in a “hit-hold” mode, and the current profile may comprise: a first constant value configured to cause the valve to be moved into an initial hit closed position; and a second constant value, lower than the first constant value, configured to cause the valve to be held in a maintained hold closed position. The first constant value may be substantially double the second constant value.

The current profile may be at substantially zero current when the valve is open. The current profile may be at substantially a constant current when the valve is closed.

The valve may be configured to operate in a “hit-hold” mode, and the current profile may comprise: a first constant value configured to cause the valve to be moved into an initial hit closed position; and a second constant value, lower than the first constant value, configured to cause the valve to be held in a maintained hold closed position.

In a further aspect there is provided an air spring system for a vehicle, comprising a multi-chamber air spring; and any control system described herein. The air spring may comprise two chambers separated by a valve. The air spring may comprise three chambers, wherein a first and a second chamber are separable by a first valve, and the second and a third chamber are separable by a second valve. One or more valves of such an air spring may be solenoid valves.

In a further aspect there is provided a vehicle suspension system comprising any air spring system disclosed herein.

In a further aspect there is provided a method of operation of a multi-chamber air spring, the multi-chamber air spring comprising at least a first chamber and a second chamber and a valve therebetween, the method comprising: receiving a close signal to cause the valve to close; determining a current profile in dependence on the close signal, the current profile indicative of a current to apply to the valve to cause the valve to close, wherein the current profile comprises a curved portion in which the current increases with a decreasing slope of curvature as a function of time; and outputting the current profile to the valve to cause the valve to close according to the current profile.

In a further aspect there is provided a computer software which, when executed on a processor of any control system disclosed herein, is arranged to perform any disclosed herein. Optionally the computer software is stored on a computer readable medium. Optionally the computer software is tangibly stored on a computer readable medium.

In a further aspect there is provided a non-transitory, computer-readable storage medium storing instructions thereon that, when executed by one or more electronic processors of any control system disclosed herein, causes the one or more electronic processors to carry out any method disclosed here.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more examples will now be described, by way of example only, with reference to the accompanying drawings, in which:

FIG. 1 shows a control system for a multi-chamber air spring according to examples disclosed herein;

FIGS. 2a and 2b show schematic multi-chamber air springs according to examples disclosed herein;

FIG. 3 shows a system comprising a multi-chamber air spring and a control system according to examples disclosed herein;

FIGS. 4a-4c show example current profiles for controlling a valve of an air spring according to examples disclosed herein;

FIG. 5 shows an example method according to examples disclosed herein; and

FIG. 6 illustrates an example vehicle according to examples disclosed herein.

### DETAILED DESCRIPTION

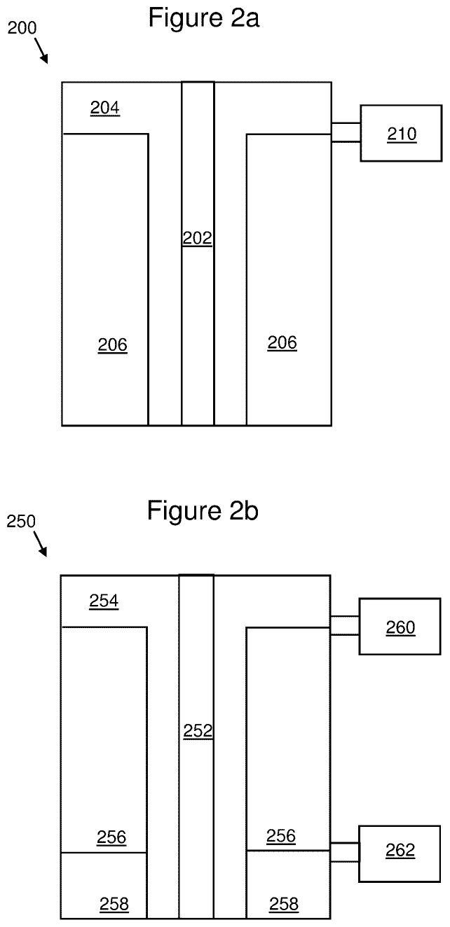

Active suspension systems may comprise multi-chamber air springs as part of the suspension system. Such air springs comprise a set of physical volumes which are connected via adjustable restrictions (e.g. valves), as discussed in relation to FIGS. 2a and 2b.

Switching between volumes may be controlled by a controller hosting a control algorithm which controls opening and closing of one or more valves which join or separate air volumes/chambers in the multi-chamber air spring. The control algorithm may monitor an array of sensor inputs from the vehicle and select the most appropriate state for the suspension system and control the valve(s) accordingly. Different states equate to different spring characteristics (e.g. stiffness) provided by adjusting the air volumes within each air spring which is used to provide a suspension force.

When electronic (e.g. solenoid) valves, which may be used as multi-chamber air spring valves, are electrically energized/de-energized (i.e. closed/opened), they may exhibit a “knock” noise. This may occur when the valve reaches a travel limit, for example when fully open or fully closed. It may be undesirable for a knock noise to be produced each time a valve is energised, as this may be perceived as a fault by the end user, and may be particularly noticeable in relation to electrical vehicle use which tend to operate more quietly than petrol/diesel vehicles. It may also be desirable to control the valve to reduce wear and tear/fatigue caused by repeated opening and closing and reaching the valve travel limits (e.g. fully opening or fully closing) while maintain good responsiveness to open/close signals.

Examples disclosed herein provide a control system for an air valve which may reduce knock noise arising from a valve of the air spring opening and closing. Examples disclosed here may allow for an air spring valve to operate and reduce knock noises arising while maintaining a fast response to a signal to close or open. Examples closed herein may allow for improved valve lifetimes by mitigating against wear caused by repeated opening and closing of the valve.

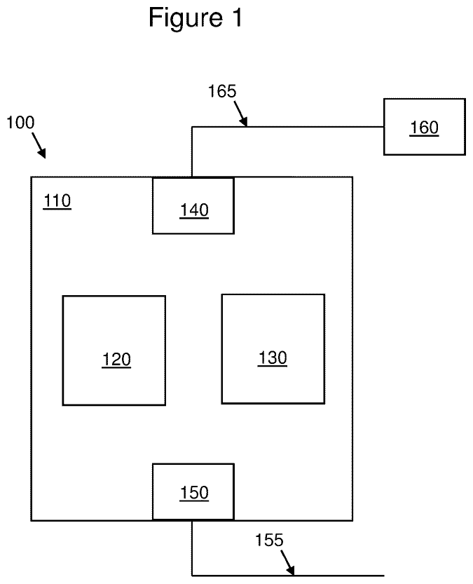

FIG. 1 shows a control system 100 for a multi-chamber air spring for a vehicle. The vehicle may be a wheeled vehicle, such as an automobile, or may be another type of vehicle. The multi-chamber air spring comprises at least a first chamber and a second chamber and a valve therebetween, for example as discussed in relation to FIGS. 2a-2b. The control system 100 may comprise one or more controllers 110. The control system 100 as illustrated in FIG. 1 comprises one controller 110, although in other examples there may be plural controllers 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 155 of the controller 110. The input 140 is arranged to receive one or more input signals 165, for example from an external computing device e.g. a close signal to cause a valve of the air spring to close. In some examples the input 140 may be arranged to receive an open signal to cause a valve of the air spring to open.

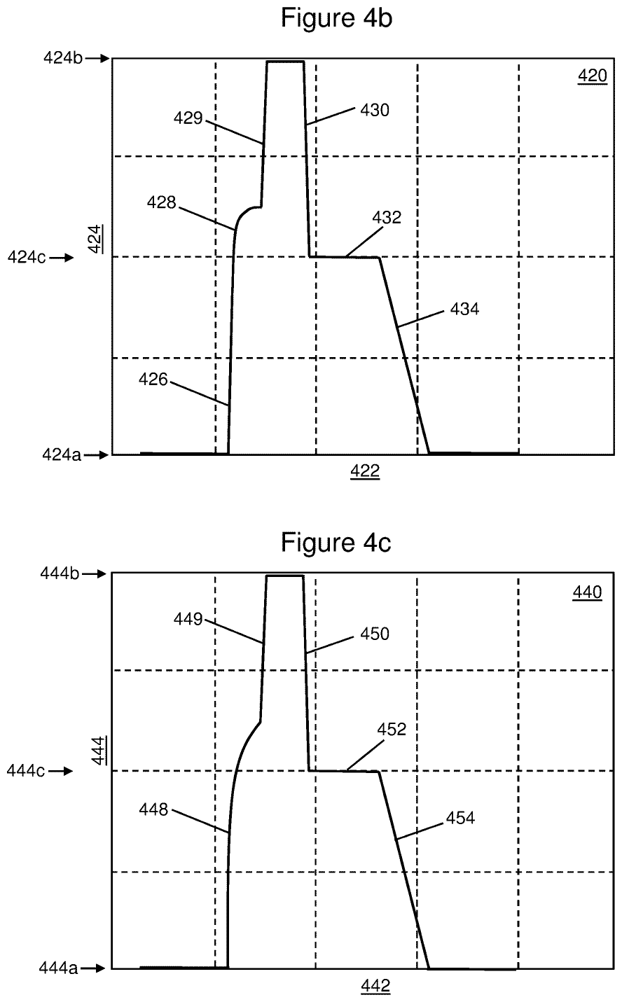

The processing means 120 is configured to determine a current profile in dependence on the received close signal. The current profile is indicative of a current to apply to the valve to cause the valve to close. The current profile comprises a curved portion in which the current increases with a decreasing slope of curvature as a function of time. In some examples the processing means 120 may be configured to determine a current profile in dependence on a received open signal. The current profile is then indicative of a current to apply to the valve to cause the valve to open. Examples are discussed in more detail with reference to FIGS. 4a-4c. The processing means 120 may provide a signal indicative of the determined current profile to the output.

The output 150 is arranged to output a signal to the valve indicative of the current profile. The signal is configured to cause the valve to close according to the current profile. For example, the output 150 may provide a signal to the valve indicating an operating current that the valve should operate using to cause the valve to close.

Advantageously, the curved portion of the current profile which is provided to the valve provides control over the valve closure with desirable properties. Because the initial part of the curved profile is steeper than the later portion, due to the decreasing slope of curvature as time increases, the valve may be controlled to be almost fully closed in a short time as this part of the curved profile has a sleep positive gradient in comparison to the later part of the curved profile. However, the later part of the curved profile has a less steep gradient compared with the earlier portion of the curved profile due to the decreasing slope of curvature, which allows the final portion of the valve movement, as the valve fully closes the aperture between air chambers, to be performed more slowly than the initial closing movement. This slower movement just before the valve closes allows for a gentler impact as the valve fully closes, thereby reducing any knocking sound arising from the valve end contacting e.g. a far wall of the aperture on closure. The softer closing motion as the valve fully closes may also act to reduce the mechanical impact on the valve, which may in turn allow for an extended mechanical life of the valve. In this way the curved profile of the current applied to the valve to cause the valve to close provides a desirable balance of fast closure time and reduced speed when the valve moves to being fully closed. This may reduce mechanical impact and reduce sound arising from the impact of the valve end to cause full separation of the air chambers between which the valve is placed.

FIGS. 2a and 2b show schematic multi-chamber air springs 200, 250 according to examples disclosed herein. These figures are schematic: the relative volume sizes of the different air chambers are not to scale and may not be representative of actual volume sizes or volume ratios between different air chambers in real air springs. FIG. 2a shows a multi-chamber air spring 200 comprising a damper 202, a first air chamber 204 and a second air chamber 206, and a valve 210. The damper 202 sits in the centre of the assembly 200, and the air spring comprising the chambers 204, 206 encapsulates it. When the valve 210 is closed, the first and second air chambers 204, 206 are separated from each other. When the valve 210 is open, the first and second air chambers 204, 206 are connected and an air spring force is achieved due to air in the first and second chambers 204, 206 together. By switching the air chamber volume available, the air spring stiffness is changed to provide different possible air spring force effects. The larger the available air volume (e.g. when the first air chamber 204 and the second air chamber 206 are connected by an open valve 210), the softer the air spring is. The smaller the air volume (e.g. when the first air chamber 204 is separated from the second air chamber 206 by the valve 210 so first air chamber 204 is available to provide an air spring force, but the second air chamber 206 is not available), the stiffer the air spring 200 is.

FIG. 2b shows a multi-chamber air spring 250 comprising a damper 252, a first air chamber 254, a second air chamber 256, and a third air chamber 258, as well as a first valve 260 configured to join or separate the first and second chambers 254, 256, and a second valve 262 configured to join or separate the second and third chambers 256, 258. The damper 252 sits in the centre of the assembly 250, and the air spring comprising the chambers 254, 256, 258 encapsulates it. When the valve 260 is closed, the first and second air chambers 254, 256 are separated from each other. When the valve 260 is open, the first and second air chambers 254, 256 are connected. When the valve 262 is closed, the second and third air chambers 256, 258 are separated from each other. When the valve 262 is open, the second and third air chambers 256, 258 are connected. By closing or opening the first and second valves 260, 262 in different combinations, different combinations of the first, second and third air chambers 254, 256, 258 are connected or separated from one another, thereby providing different sized overall air chambers to provide an air spring force. For example, if both valves 260, 262 are open then the spring rate achieved by the system is at its softest state by the three chambers 254, 256, 268 being joined to form one large air chamber. For example, if both valves 260, 262 are closed then the spring rate achieved by the system is at its stiffest state by the first chamber 254 being used without the second and third chambers 256, 268. For example, if only one of the two valves 260, 262 is closed while the other of the valves 260, 262 is open, then the air spring may provide a medium stiffness by experiencing damping from two of the three chambers without the third of the three chambers being used. Usually the stiffest spring rate is achieved by only using the chamber with the smallest volume. The damping forces which may be provided to the vehicle may be decoupled from the air spring forces provided by air springs 200, 250. Forces from both damping and air spring systems may act on the vehicle body and the wheel in some examples.

Air springs in a vehicle suspension system may allow for a vehicle to be maintained at a constant level under different loads. Furthermore, switchable air springs such as those in FIGS. 2a and 2b may be used to provide different degrees of spring stiffness, thereby allowing for a quick transition between a firm suspension for confident and safe driving behaviour, and provide a more comfortable ride, for example for long road trips.

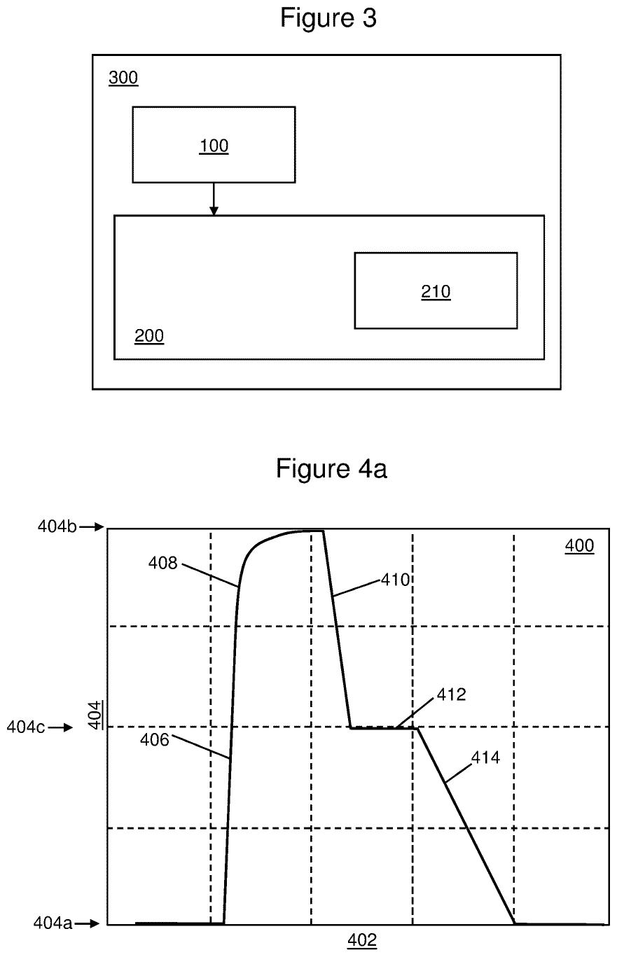

FIG. 3 shows a system 300 comprising at least one multi-chamber air spring 200 comprising at least one valve 210, such as the air springs described in relation to FIG. 2a or 2b, and a control system 100 such as that described in relation to FIG. 1. Such a system may be part of a vehicle suspension system. Air springs controlled by control systems described herein may be particularly useful in vehicle suspension systems where they may reduce knock effects due to a valve of the air spring closing and opening which may give the impression that there is a fault with the suspension, or that there is an annoying noise when the suspension air spring valves operate.

FIGS. 4a to 4c illustrate current profiles 400, 420, 440 which may all be described as comprising a curved portion 408, 428, 448 in which the current increases with a decreasing slope of curvature as a function of time. The curves as they are shown in FIGS. 4a to 4c are schematic and do not accurately depict any particular mathematical function curve. The current profiles 400, 420, 440 each show a plot of current (A) 402, 422, 442 against time(s) 404, 424, 444. The current profiles 400, 420, 440 show a current which may be applied to a valve in a multi-chamber air spring to close and open the valve. The valve is configured to close by moving on a closure travel path from an open position at the start of the closure travel path in which the first and second chambers are connected, to a closed position at the end of the closure travel path in which the first and second chambers are separated by the valve. The valve is configured to open by moving on an opening travel path from the closed position at the start of the opening travel path in which the first and second chambers are separated by the valve, to the open position at the end of the opening travel path in which the first and second chambers are connected.

The curved portion 408, 428, 448 of the current profiles 400, 420, 440 is indicative of a current to apply to the valve at the end of the closure travel path to cause the valve to reach the closed position. By controlling the valve movement at the end of the travel to a closed position using a curved current profile 408, 428, 448, the valve close may be performed to provide a slower (i.e. softer) closure and thereby reduce knock sounds being formed due to the valve hitting the far wall to completely close the aperture between air chambers.

In FIG. 4a, the current profile 400 shows an increasing current portion 406, 408 from a low current value 404a to a high current value 404b. The low current value 404a may be approximately OA, for example. The high current value 404b may be of the order of 1A-5A, for example. The increasing current portion 406, 408, when provided to the valve, causes the valve to energise and therefore close. In this example, the increasing current portion 406, 408 comprises a linear portion 406 followed by the curved portion 408. In this way most of the closure of the valve can take place using the increasing linear current portion 406 and the increasing curved current portion 408 takes place in the part of the closure travel path where it is beneficial (i.e. near to and causing complete closure of the valve). Because the curvature of the curved portion has a decreasing slope of curvature, it may be said that the current in the curved portion exhibits a gradually decreasing gradient, or slope. This means that the rate of change of the increasing current decreases with time, which causes the velocity with which the valve closes to gradually decrease with time. That is, the closing valve decelerates as it approaches the full closure point at the end of the closure travel path. The gradual decreasing gradient of the curved current profile 428 causes the moving valve to decelerate as it reaches full closure, to reduce mechanical impact and noise arising from full closure. When the current is at the high current value 404b, the valve is fully closed.

The valve may be de-energised by reducing the current (in a closed current reduction portion 410) to a mid-value 404c between the low and high current values 404a, 404b and remain closed. At the mid-value current 404c the valve remains closed but requires less current than the high current value 404b to remain closed. Such a mid-value current 404c when the valve remains closed may be called a “hold” current. The valve may remain closed when the current profile 400 is in the closed constant current portion 412 for as long as the valve is to be closed. Such operation may be considered to be “hit-hold” mode operation in which a first initial current is reached to cause valve closure followed by a second lower current which causes the valve to, once closure is achieved, to remain closed. The current profile 400 therefore comprises a decreasing current 410, 412, 414. The decreasing portion 410 causes the valve to move from a “hit” operation to the “hold” operation where the hold current is maintained in flat current portion 412 around the mid-current value 404c.

When the valve is to be opened, the current may reduce from the mid-value current 404c to the low current value 404a in an opening current reduction portion 414. This opening current reduction portion 414 in this example is a linear decreasing current portion to apply to the valve to cause the valve to move from the closed position to the open position.

Overall FIG. 4a may be considered to illustrate a current profile 400 which comprises: a closure portion 406, 408 indicative of a current configured to cause the valve to close, the closure portion comprising a linear current increase 406 and the curved portion 408; a hold portion 412 at a constant non-zero current indicative of a current configured to maintain the valve in a closed position; and an opening portion 414 indicative of a current configured to cause the valve to open, the opening portion comprising a linear current decrease.

In FIG. 4b, the current profile 420 shows an increasing current portion 426, 428, 429 from a low current value 424a to a high current value 424b. The low current value 424a may be approximately 0A, for example. The high current value 424b may be of the order of 1A-5A, for example. The increasing current portion 426, 428, 429, when provided to the valve, causes the valve to energise and therefore close as before. In this example, the increasing current portion 426, 428, 429 comprises a first linear portion 426 followed by the curved portion 428 followed by a further linear portion 429. In this way, for example if the valve is operating in a hit-hold mode, most of the closure of the valve can take place using the first increasing linear current portion 426, and the increasing curved current portion 428 takes place in the part of the closure travel path where it is beneficial (i.e. close to and causing complete closure of the valve). As before, the gradual decreasing gradient of the curved current profile 428 causes the moving valve to decelerate as it reaches full closure to reduce mechanical impact and noise arising from full closure.

Following the closure of the valve once the current reaches the end of the curved current portion 428 in the mid-value current region 424c the valve is closed. A further current increase may take place in a further linear current portion 429. The second linear increasing current portion 429 takes the current value up to a high “hit” value once closure has taken place at the end of the curved portion 428 to ensure good closure of the valve and helps to ensure that a good seal is provided by the closed valve.

The valve may then be de-energised by reducing the current (in a closed current reduction portion 430) from the high current value 424b to within the mid-value current range 424c between the low and high current values 424a, 424b. At the mid-value current 424c the valve remains closed in a constant current portion 432 but requires less current than the high current value 424b to remain closed. Such a mid-value current 424c may be called a “hold” current. The valve may remain closed when the current profile 420 is in the closed constant current portion 432 for as long as the valve is to be closed. When the valve is to be opened, the current may reduce further from the mid-value current 424c to the low current value 424a in an opening current reduction portion 434.

Overall FIG. 4b may be considered to illustrate a current profile 420 which comprises: a closure portion 426, 428, 429 indicative of a current configured to cause the valve to close, the closure portion comprising a linear current increase 426 and the curved portion 428; a hold portion 432 at a constant non-zero current indicative of a current configured to maintain the valve in a closed position; and an opening portion 434 indicative of a current configured to cause the valve to open, the opening portion comprising a linear current decrease. FIG. 4b also illustrates that the closure portion further comprises a second linear current increase 429 following the curved portion 428.

FIG. 4c is similar to FIG. 4b, but the current profile 440 shows an increasing current portion 448, 449 from a low current value 444a to a high current value 444b which comprises a first curved portion 448 followed by a further linear portion 449. The curved portion 448 operates from the low current value 44a to within the mid-value current range 444c. The increasing current portion 448, 449, when provided to the valve, causes the valve to energise and therefore close as before. In this example, the increasing current portion 448, 449 comprises the curved portion 448 followed by a further linear portion 449. As before, if the valve is operating in a hit-hold mode, most of the closure of the valve can take place using the first part of the curved current portion 448 which has a steeper gradient, compared with the later portion of the curved current portion 448 which has a shallower gradient. The steeper part of the curved current portion 448 takes place in the initial closure of the valve, and the shallower later portion of the increasing curved current portion 448 controls the part of the closure travel path where it is beneficial (i.e. close to and causing complete closure of the valve).

The remainder of the current profile 440 is similar to that of previous FIGS. 4a-4b, comprising a further linear current increase 449 to help ensure that a good seal is provided by the closed valve, valve de-energising by a decreasing current 450 to within the mid-value current range 444c causing the valve to remain closed but at a lower current than the high current value 444b. The valve remains closed in the constant hold current portion 452 and when the current is reduced in the opening current reduction portion 454 the valve is opened.

The closed current reduction portions 410, 430, 450 and opening current reduction portions 414, 434, 454 in these examples are shown as linear current reductions over time. In some examples the gradient of the two portions 410, 430, 450; 414, 434, 454 may be substantially the same. In other examples the gradient of one of the portions 410, 430, 450; 414, 434, 454 may differ from the gradient of the other portion 410, 430, 450; 414, 434, 454. In other examples one or more of the current reduction portions 410, 430, 450; 414, 434, 454 may not necessarily be linear and may be or be at least partly non-linear (e.g. exponentially decreasing). For example, to reduce possible knock sounds and/or mechanical wear caused by the valve opening, the opening current reduction portion 414, 434, 454 may have a curved current profile which reduces over time, and which has a decreasing slope of curvature so the current initially reduces more quickly and later, when close to fully opening, the current reduction takes place more slowly. Similarly to the curved portion of the current profile used to close the valve, a curved portion of the current profile may be used to open the valve and may decelerate the valve movement when the valve is close to being fully open. An exponentially decreasing current is an example of a current decrease having a decreasing slope of curvature.

In the examples discussed above, the curved portion 408, 428, 448 forms a part of the overall current profile 400, 420, 440, and there is flexibility in the part of the increasing current profile where the curved portion 408, 428, 448 is located for different control. For example, some valves may operate in an improved way with a curved profile 428 midway between two linear portions as in FIG. 4b, whereas other valves may operate in an improved way with a curved profile 408 and the end of the increasing current portion as in FIG. 4a. In some examples there may be plural curved portions, for example if the valve movement occurs in stages, such as a release stage and a full closure stage. Other examples may be envisaged.

The first current value 404b, 424b, 444b may be substantially double the second constant current value 404c, 424c, 444c in some examples. The curved portion 408, 428, 448 of the current profile may in some examples may extend over a current range which includes the hold closure current 412, 432, 452 value.

The nature of the particular curve used for the curved portion may be tailored depending on, for example, the nature of the increasing current which provides a desired valve closure movement, and/or the nature of the electronic components used to cause the current control. In some examples the curved portion may be indicative of an exponential/logarithmic current variation as a function of time. Such a logarithmic function may comprise, for example, log₂, log₁₀, In (logₑ), dependent on the particular curvature desired. A logarithmic current profile may provide a desirable relationship comprising a relatively steep initial current increase and a relative shallow current increase at the end of the curve. In some examples the curved portion may be indicative of a trigonometric current variation as a function of time, e.g. a positive increasing portion of a sine wave wherein the current increases with a decreasing gradient. In some examples the curved portion may be indicative of a geometric shape such as a portion of a circle or oval wherein the current increases with a decreasing gradient. Other examples may be envisaged—for example, in FIG. 4b, curved section 428 may be an exponential curve. Similar curved profiles may be used in examples having a curved current profile having a decreasing current to open the valve and cause the valve to decelerate at the end of the valve travel path close to being fully open.

In a particular example, a dedicated function may be implemented that generates the switching profile. The function may have one or more parameters which allow for several types of profiles to be generated (for example, allowing for different hot currents, hold currents, slope gradients, profile sections (e.g. linear and curved) and/or curve functions). A particular profile may be selected exclusively for all switching events (for example in cases where all valves are the same specification) in some examples. Alternatively, the switching profile may be dynamically changed, depending on driving conditions, in some examples.

The control system 100 may be configured to determine the current profile 400, 420, 440 by retrieving the current profile from a stored profile repository in some examples. In some examples the current profile may be a fixed (predetermined) profile, and for example may be programmed into a circuit component such as an integrated circuit (IC) or field-programmable gate array (FPGA) or other part of the valve controller 100, or may be stored in a memory for retrieval by the processor. In some examples, to help provide a flexible implementation, the profiles are generated via software and a representative current demand value signal is sent to an IC that uses the current demand value signal to build up the current (e.g. the IC may comprise an ASIC/FPGA or a gate driver unit).

The control system 100 in some examples may be configured to determine the current profile by determining at least part of the current profile in accordance with one or more detected vehicle parameters. For example, if the vehicle is determined to be travelling on a flat fast road surface such as a driving track or motorway/highway, a different current profile may be beneficial compared to the vehicle to travelling on rough terrain or off-road. This may be because different air spring valve configurations may be more likely to be in use (i.e. different valves may be likely to be opened or closed) dependent on the driving conditions, since different suspension characteristics may be desirable when driving off-road compared with city driving for example. In some examples the current profile may be a dynamic profile which is determined in dependence on a vehicle parameter such as road surface, vehicle speed, road surface gradient, weather, environmental temperature, or other driving or environmental factor(s).

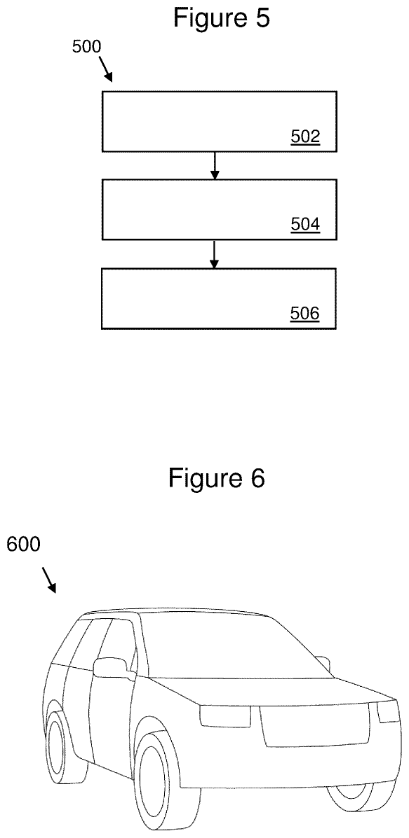

FIG. 5 shows an example method 500 of operation of a multi-chamber air spring. The multi-chamber air spring comprises at least a first chamber and a second chamber and a valve therebetween as described above. The method 500 comprises: receiving a close signal to cause the valve to close 502; determining a current profile in dependence on the close signal 504, the current profile indicative of a current to apply to the valve to cause the valve to close, wherein the current profile comprises a curved portion in which the current increases with a decreasing slope of curvature as a function of time; and outputting the current profile to the valve to cause the valve to close according to the current profile 506. The method 500 may be performed by the control system 100 illustrated in FIG. 1. In particular, the memory 130 may comprise computer-readable instructions (e.g. computer software) which, when executed by the processor 120 of a control system 100 disclosed herein, perform a method 500 as disclosed herein. Also disclosed herein is a non-transitory, computer-readable storage medium storing instructions thereon that, when executed by one or more electronic processors of a control system 100 as disclosed herein, causes the one or more electronic processors to carry out a method 500 as disclosed herein.

The blocks illustrated in FIG. 5 may represent steps in a method 500 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples.

FIG. 6 illustrates an example vehicle according to examples disclosed herein, e.g. comprising a control system 100 or system 300 disclosed herein. The vehicle 600 in the present embodiment is an automobile, such as a wheeled vehicle, but it will be understood that the control system and active suspension system may be used in other types of vehicle.

As used here, ‘connected’ means either ‘mechanically connected’ or ‘electrically connected’ either directly or indirectly. Connection does not have to be galvanic. Where the control system is concerned, connected means operably coupled to the extent that messages are transmitted and received via the appropriate communication means. The term “control system” may be understood to cover a controller, control module, or control element and need not necessary be a multi-element or distributed system (although it may be in some examples).

It will be appreciated that various changes and modifications can be made to the present disclosed examples without departing from the scope of the present application as defined by the appended claims. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for a multi-chamber air spring for a vehicle, the multi-chamber air spring comprising at least a first chamber and a second chamber and a valve therebetween, the control system comprising one or more controllers, the control system configured to:
receive a close signal to cause the valve to close;
determine a current profile in dependence on the close signal, the current profile indicative of a current to apply to the valve to cause the valve to close, wherein the current profile comprises a curved portion in which the current increases with a decreasing slope of curvature as a function of time; and
output a signal to the valve indicative of the current profile, the signal configured to cause the valve to close according to the current profile.

17. The control system of claim 16,
wherein the valve is configured to close by moving on a closure travel path from an open position at the start of the closure travel path in which the first and second chambers are connected, to a closed position at the end of the closure travel path in which the first and second chambers are separated by the valve, and
wherein the curved portion of the current profile is indicative of a current to apply to the valve at the end of the closure travel path to cause the valve to reach the closed position.

18. The control system of claim 16, wherein the current profile comprises a linear portion and the curved portion.

19. The control system of claim 18, wherein the current profile comprises the linear portion followed by the curved portion.

20. The control system of claim 19, wherein the current profile comprises a first linear portion, followed by the curved portion, followed by a second linear portion.

21. The control system of claim 16, configured to determine the current profile by one or more of:
retrieving the current profile from a stored profile repository; and
determining at least part of the current profile in accordance with one or more detected vehicle parameters.

22. The control system of claim 16, wherein the current profile further comprises a decreasing current portion, and wherein the control system is configured to:
receive an open signal to cause the valve to open;
determine a current profile in dependence on the open signal, the current profile indicative of a decreasing current to apply to the valve to cause the valve to open; and
output the current profile to the valve to cause the valve to open according to the current profile.

23. The control system of claim 22,
wherein the valve is configured to open by moving on an opening travel path from the closed position at the start of the opening travel path in which the first and second chambers are separated by the valve, to the open position at the end of the opening travel path in which the first and second chambers are connected, and
wherein the current profile is indicative of a decreasing current comprising a linear decreasing current portion to apply to the valve to cause the valve to move from the closed position to the open position.

24. The control system of claim 23, wherein the decreasing current portion of the current profile comprises the decreasing linear portion and a further decreasing portion.

25. The control system of claim 16, wherein the current profile comprises:
a closure portion indicative of a current configured to cause the valve to close, the closure portion to apply to the valve to cause the valve to close, the closure portion comprising a linear current increase and the curved portion;
a hold portion at a constant non-zero current indicative of a current configured to maintain the valve in a closed position; and
an opening portion indicative of a current configured to cause the valve to open, the opening portion comprising a linear current decrease.

26. The control system of claim 25, wherein the closure portion further comprises a second linear current increase following the curved portion.

27. A vehicle suspension system, comprising:
a multi-chamber air spring; and
the control system of claim 16.

28. A vehicle comprising a control system according to claim 16.

29. A vehicle comprising a suspension system according to claim 27.

30. A method of operation of a multi-chamber air spring, the multi-chamber air spring comprising at least a first chamber and a second chamber and a valve therebetween, the method comprising:
receiving a close signal to cause the valve to close;
determining a current profile in dependence on the close signal, the current profile indicative of a current to apply to the valve to cause the valve to close, wherein the current profile comprises a curved portion in which the current increases with a decreasing slope of curvature as a function of time; and
outputting the current profile to the valve to cause the valve to close according to the current profile.

31. Computer software which, when executed on a processor of a control system, is arranged to perform a method according to claim 30.
